(19) United States
(12) Patent Application Publication
(10) Pub. No.: US 2024/0165636 A1
(43) Pub. Date: May 23, 2024

(54) FRONT MOUNT MAGNETIC SWEEPER APPARATUS

(71) Applicant: Bluestreak Equipment Inc., Delhi (CA)

(72) Inventors: Emmett TOWNSEND, Paris (CA); Brian WEBER, Delhi (CA)

(21) Appl. No.: 18/513,004

(22) Filed: Nov. 17, 2023

Related U.S. Application Data
(60) Provisional application No. 63/384,222, filed on Nov. 17, 2022.

(51) Int. Cl. B03C 1/08; E01H 1/14; H01F 7/02

(52) U.S. Cl. CPC B03C 1/08; E01H 1/14; H01F 7/0252; B03C 2201/20; B03C 2201/30

(57) ABSTRACT

A front mount mechano-hydraulic magnetic sweeper apparatus having a debris collection and retention system. The magnetic sweeper apparatus addresses ferrous debris pickup with ground tracking capabilities ahead of its swept path. The magnetic sweeper apparatus features a large magnet hanging out-front of the vehicle or primary mover, which allows for ferrous debris pickup and retention utilizing complete wrap around technology. Objects as small as paperclips, up to large items like rail spikes and steel axles, are able to be safely retrieved and retained beneath the magnet. Obstructions such as sharp ramps, speedbumps, potholes, small curbs, ruts, and other rough terrain can be traversed without having to sacrifice lifting the magnet which reduces magnetic performance. A quadric cycle chain mechanism allows for magnet clean off and debris storage in a smooth and controlled motion.

### CROSS REFERENCE TO RELATED APPLICATIONS

This application claims priority to and the benefit of U.S. Provisional Application Ser. No. 63/384,222, entitled “FRONT MOUNT MAGNETIC SWEEPER APPARATUS”, filed on Nov. 17, 2023, the disclosure of which is incorporated herein by reference in its entirety.

### BACKGROUND

The field of the disclosure relates to sweeper apparatuses, in particular to a magnetic sweeper apparatus.

This disclosure addresses the need to pick up hazardous ferrous debris along all roadways, laneways, and shoulders. Road debris is found to be an apparent hazard and includes substances, materials and objects that are foreign to a traditional road environment, produced both by human and vehicular sources. These road hazards frequently cause tire punctures on road maintenance crew vehicles as well as passenger vehicles.

Areas adjacent to major roads have an increased probability to contain debris that are hazardous causing tire punctures, or other vehicle mishaps. Countermeasures for roadway hazards rely heavily on workers manually picking up, or operating a boom-style apparatus, to collect road debris. This debris normally comes in ferrous form including large bolts, wire, chain, construction tools, and other miscellaneous steel parts falling from vehicles, as well as nonferrous forms including tire shrapnel, bottles and cans, downed branches, or any household debris and waste imaginable.

In many cases, the debris that is causing downtime and costly repairs for service vehicles and passenger vehicles is often not able to be seen while travelling at speed, and thus is not collected unless it is spotted. These smaller types of debris that are often overlooked are an area of high concern as they are one of the causes of tire punctures in all vehicles. Reliable debris collection systems do not readily exist for smaller debris types that cannot be seen easily including nails, screws, bolts, and smaller steel components that fall off vehicles.

There is a desire for an option for reliable debris collection of metallic objects or debris.

### BRIEF DESCRIPTION OF THE DRAWINGS

FIG. 1 is a diagram of a front view of an exemplary magnetic sweeper.

FIG. 2 is a line diagram of a perspective view of an exemplary magnetic sweeper.

FIG. 3 is a line diagram of a top view of an exemplary magnetic sweeper.

FIG. 4 is a line diagram of a front view of an exemplary magnetic sweeper.

FIG. 5 is a line diagram of a right-side view of an exemplary magnetic sweeper.

FIG. 6 is a line diagram of an exemplary magnetic sweeper with mounting brackets.

FIG. 7 is a diagram of a front view of the dimensions of an exemplary magnetic sweeper.

FIG. 8 is a diagram illustrating a clean-off position and a sweeping position of an exemplary magnetic sweeper.

FIG. 9 is a diagram illustrating the movement from sweeping position to a clean-off position of an exemplary magnetic sweeper.

FIGS. 10A to 10E are diagrams illustrating operation of an exemplary magnetic sweeper.

FIGS. 11A and 11B are line drawings illustrating the quadric cycle chain mechanism.

FIG. 12 is a diagram that illustrates the Gauss (G) measurements for the magnetic strength of the magnetic sweeper.

### SUMMARY

A front mount mechano-hydraulic magnetic sweeper apparatus having a debris collection and retention system. The magnetic sweeper apparatus addresses ferrous debris pickup with ground tracking capabilities ahead of its swept path. The magnetic sweeper apparatus features a large magnet hanging out-front of the vehicle or primary mover, which allows for ferrous debris pickup and retention utilizing complete wrap around technology. Objects as small as paperclips, up to large items like rail spikes and steel axles are able to be safely retrieved and retained beneath the magnet. Obstructions such as sharp ramps, speedbumps, potholes, small curbs, ruts, and other rough terrain can be traversed without having to sacrifice lifting the magnet which reduces magnetic performance. A quadric cycle chain mechanism allows for magnet clean off and debris storage in a smooth and controlled motion.

### DETAILED DESCRIPTION

A front mount mechano-hydraulic magnetic sweeper apparatus having a debris collection and retention system. The magnetic sweeper keeps the safety of vehicle operators in mind as it offers extreme control of the magnet without leaving the vehicle cab. The mechano-hydraulic system allows for semi-automatic clean-off which wipes the bottom of the magnet off by using in-cab hydraulic controls, or a wireless remote accessory.

The automatic clean-off is a system in which the collected debris is placed into on-board debris bins via the use of a pivoting stainless-steel or aluminum pan. A series of nylon ropes and steel extension springs are used in combination with the hydraulic system which allows the debris to be released from the magnet as it is raised, placing it into the on-board collection bins. Magnetic clean-off is an important aspect of ferrous debris pickup as the more debris that is collected underneath and around the magnet, the less the magnet can hold.

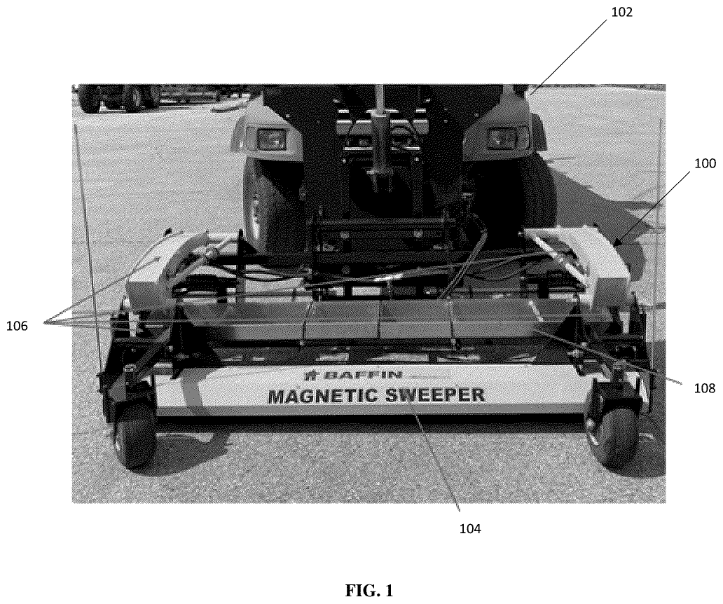

FIG. 1 is a diagram of a front view of an exemplary magnetic sweeper attachment. According to FIG. 1, the magnetic sweeper attachment 100 (or magnetic sweeper for short) is mounted at the front of an industrial vehicle 102. Industrial vehicle 102 may include snow plows, flatbed trucks, tankers, reefers and tow trucks.

According to FIG. 1, the magnetic sweeper consists of a 650 lb hanging magnet 104, a plurality of 1.65 cubic feet aluminum debris bins 108 for debris storage and a quadric cycle chain mechanism 106 that allows for magnet clean off and debris storage in a smooth and controlled motion. Hanging magnet 104 is a permanent magnet that can be a Ceramic 8 magnet, Alnico magnets and rare earth magnets (e.g., neodymium and samarium cobalt magnets) or other similar magnets. Dimensions of the hanging magnet 104 are approximately 94.5″ length by 6″ width by 5″ height.

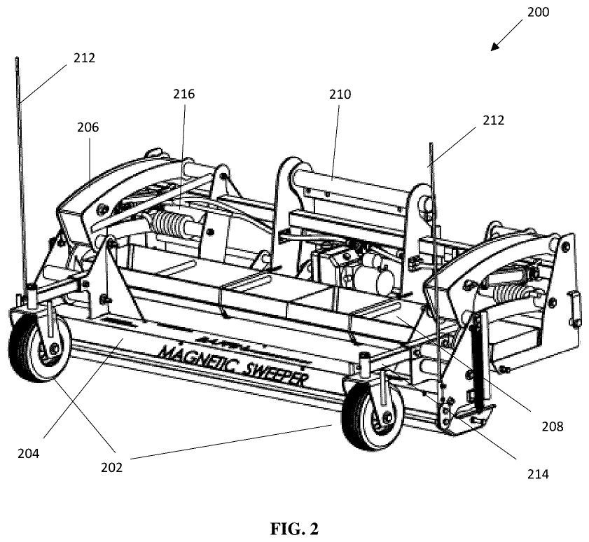

FIG. 2 is a line diagram of a perspective view of an exemplary magnetic sweeper. According to FIG. 2 magnetic sweeper (or magnetic sweeper attachment) 200 consists of front wheels 202, hanging magnet 204, quadric cycle chain mechanism 206, a plurality of aluminum debris bins 208, vehicle mounting bracket 210, fibre-reinforced plastic (FRP) marker 212, torsion spring 216 and front wheel fork 214.

According to FIG. 2, the FRP marker 212 provides a visual line of sight for the operator of the vehicle to know the approximate outer limits of the attachment. In most cases, the top of the FRP marker may be the only part they can see. According to FIG. 2, the torsion spring 216 alleviates roughly half of the weight of the hanging magnet assembly providing smoother ground tracking ability. Furthermore, torsion spring 216 also lessens the shock load into the frame when the wheels touch the ground, thereby preventing damage to the magnetic sweeper and the plow system on the vehicle.

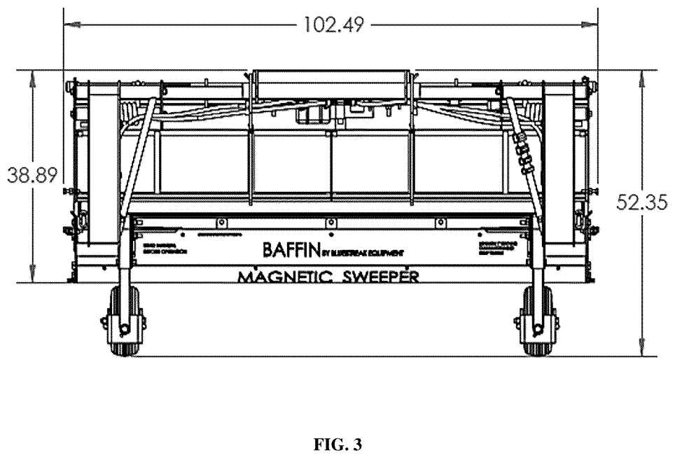

FIG. 3 is a line diagram of a top view of an exemplary magnetic sweeper. According to FIG. 3, the dimensions of the magnetic sweeper are 102.49″ width by 38.89 length with a total length of 52.35″ to the tip of the front wheel.

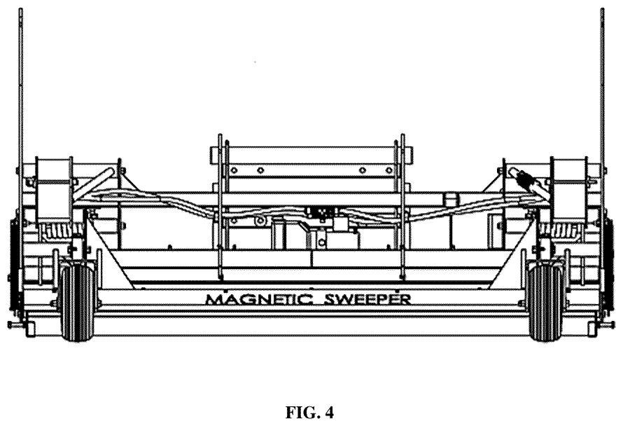

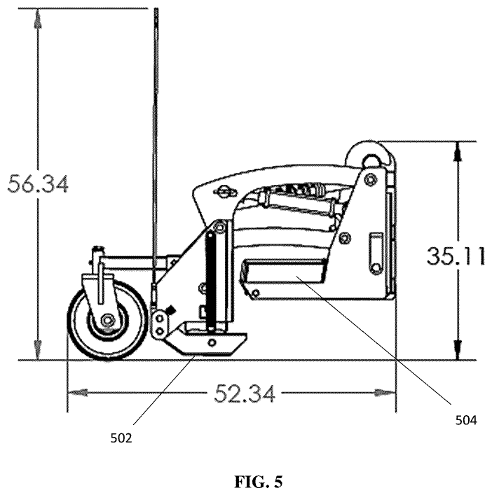

FIG. 4 is a line diagram of a front view of an exemplary magnetic sweeper. FIG. 5 is a line diagram of a right-side view of an exemplary magnetic sweeper. According to FIG. 5, the dimensions include a total length of 52.35″ by 35.11″ height (to back of device). The total height including the height from the ground clearance to the tip of the FRP marker is 56.34″. According to FIG. 5, there is a stainless steel pan 502 that forms the bottom surface of the hanging magnet (magnet platform). Stainless steel pan 502 creates a separation to release metallic debris that is collected in collection bin 504.

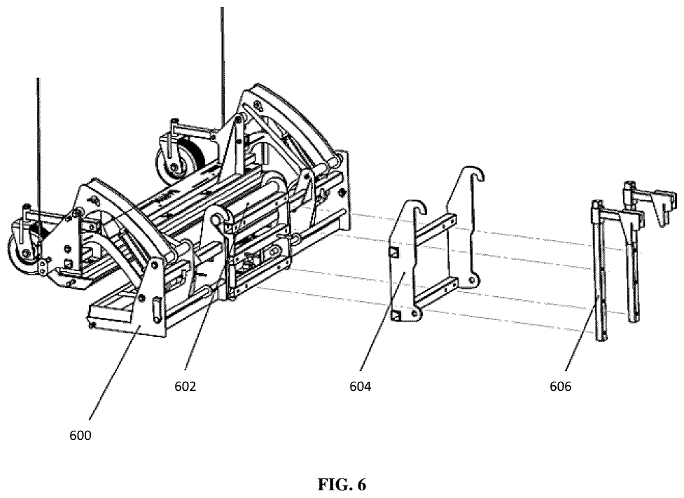

FIG. 6 is a line diagram of a perspective view of an exemplary magnetic sweeper with mounting brackets. According to FIG. 6, the magnetic sweeper 600 comes standard with a standard universal mounting plate 602 for attaching to the front of a vehicle (or industrial vehicle). This allows the magnetic sweeper 600 to be lifted on and off the vehicle quickly without unbolting or dismantling components.

According to FIG. 6, there are three mount alternatives:
1. Blank Universal Mounting Bracket 602—standard with magnetic sweeper 600 that allows the customer to weld or bolt on other parts to this bracket to rigidly connect the universal mounting bracket to the vehicle.
2. Viking Quick Release Connector 604—accessory that allows the customer to connect to some Viking front mount plow brackets that exist on the front of some commercial trucks.
3. Custom Fabricated Bracket Mount 606—must be made by customer, if the customer has no existing bracket on the front of their vehicle, or a system that is not capable of attaching the above two, fabrication is required to mount the sweeper to the vehicle.

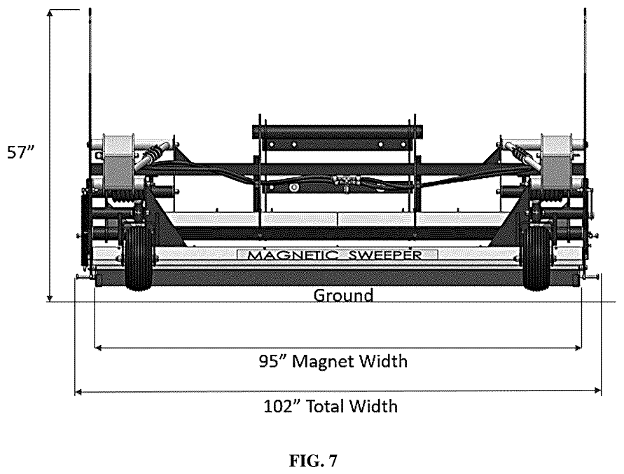

FIG. 7 is a diagram of a front view of the dimensions of an exemplary magnetic sweeper. According to FIG. 7, the dimensions of the magnetic sweeper consist of a total width of 102″, a magnet width of 95″, a total height of 57″ and a depth of 52.35″ (shown in FIG. 3).

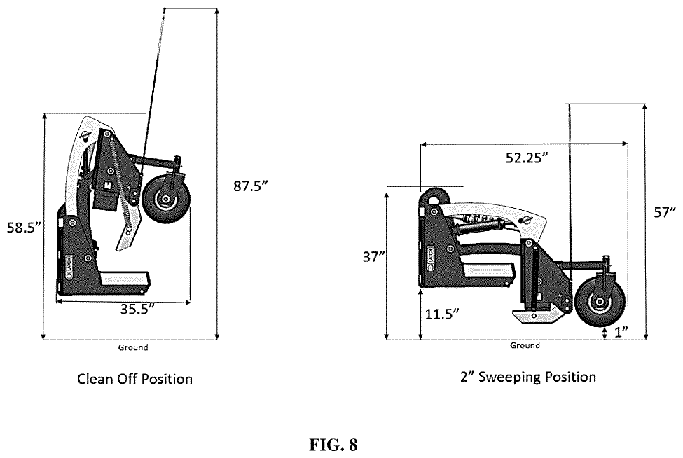

FIG. 8 is a diagram illustrating a clean-off position and a sweeping position of an exemplary magnetic sweeper. According to FIG. 8, in clean-off position, the front wheel and assembly is lifted off the ground and the quadric mechanism is in vertical position. In a clean-off position, metallic debris is “cleaned-off” or released from the magnet of the magnetic sweeper. According to FIG. 8, the dimensions of the magnetic sweeper in clean-off position is 35.5″ length by 87.5″ total height (i.e., up to the tip of the FRP marker) with a height of 58.5″ to the top of the quadric mechanism.

According to FIG. 8, in sweeping position, the front wheel has a 1″ clearance from the ground (i.e., 2″ sweeping position of sweep height corresponding to the 2″ height of the magnet) and the assembly is configured in a horizonal position to the ground. The sweeping position refers to the operating position wherein the magnetic sweeper is configured to pick up metallic debris. According to FIG. 8, the dimensions of the magnetic sweeper in sweeping position is 52.25″ length by 57″ total height (i.e., up to the tip of the FRP marker). The height of the quadric mechanism is 37″ with a clearance of 11.5″, the height of the bottom surface of the quadric mechanism to the ground.

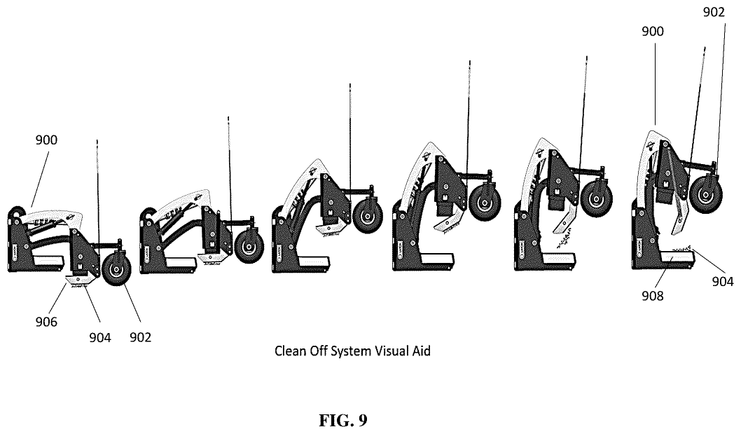

FIG. 9 is a diagram illustrating the movement from sweeping position to a clean-off position of the exemplary magnetic sweeper. According to FIG. 9, the front wheel 902 and assembly of the magnetic sweeper 900 can be seen moving from a horizontal position (left image) to a vertical position (right image).

According to FIG. 9, metallic debris 904 can be see magnetically deposited (or attracted) to the bottom surface (or pan) of the hanging magnet 906 in the horizontal position. In the vertical position, the metallic debris (or magnetic debris) is shown to be deposited in the storage bin 908.

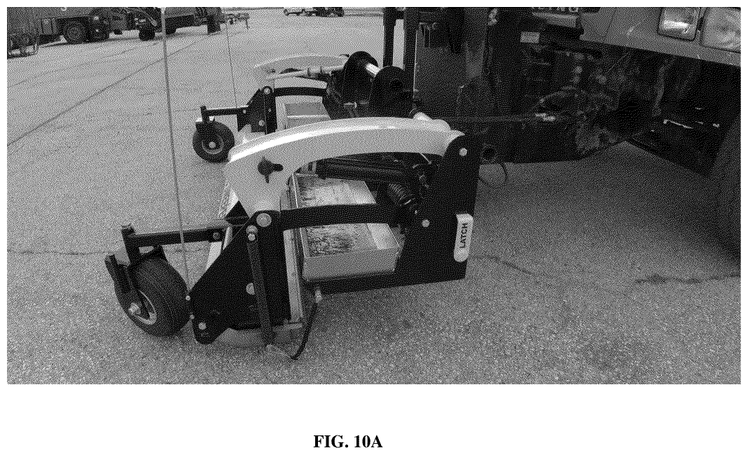

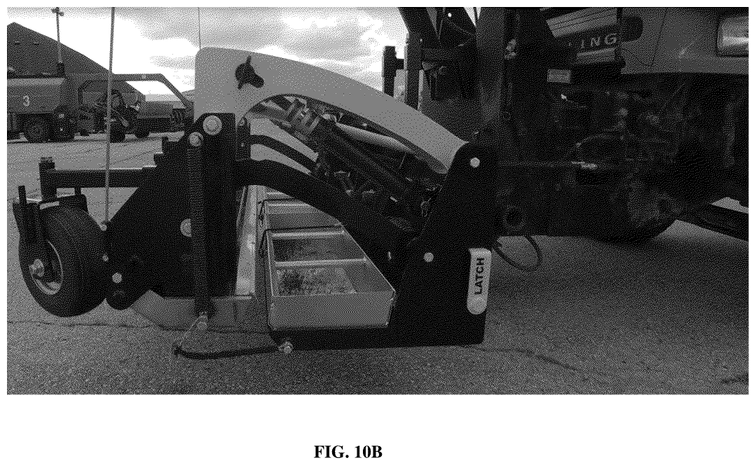

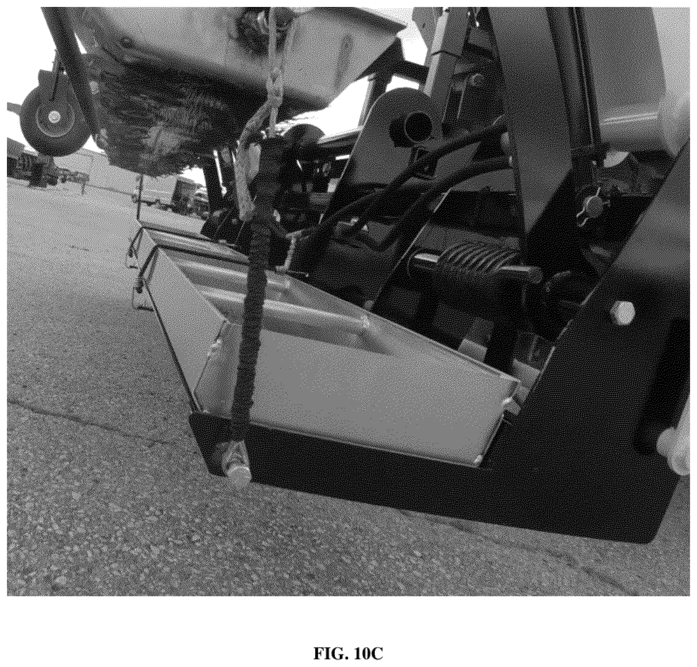

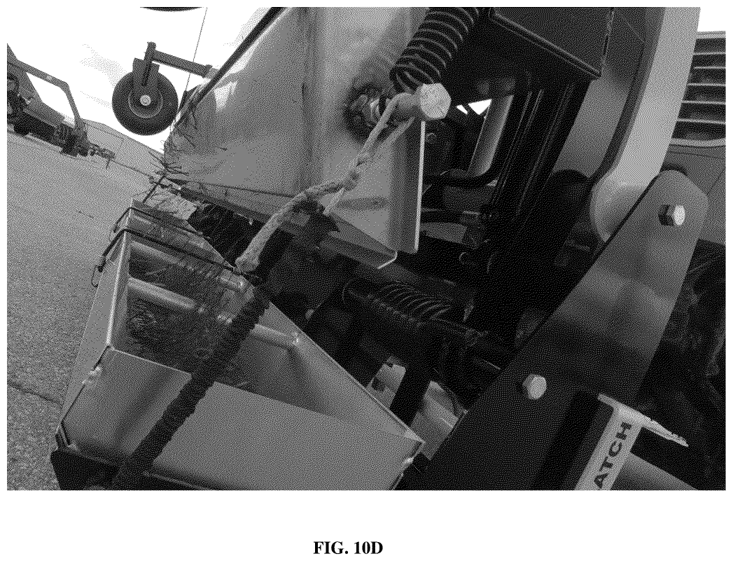

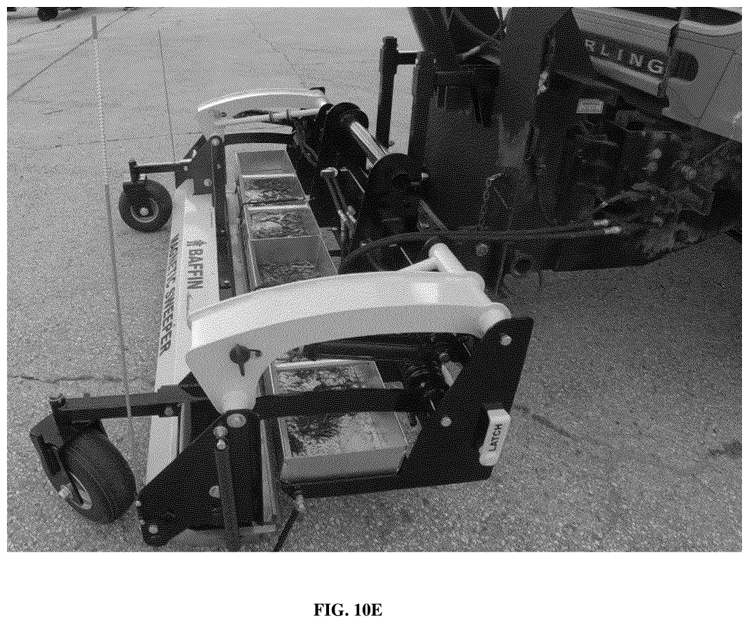

FIGS. 10A to 10E are diagrams illustrating operation of the exemplary magnetic sweeper. FIG. 10A shows the magnetic sweeper in a sweeping position. FIGS. 10B and 10C show the front assembly being lifted where ferrous objects (i.e., metallic debris) are shown clinging to the magnet. FIG. 10D shows the front assembly in a vertical position (i.e., clean-off position) where the ferrous material (i.e., metallic debris) is deposited into storage bins. Finally, FIG. 10E illustrates the front assembly returning to original sweeping position.

### Quadric Cycle Chain Mechanism

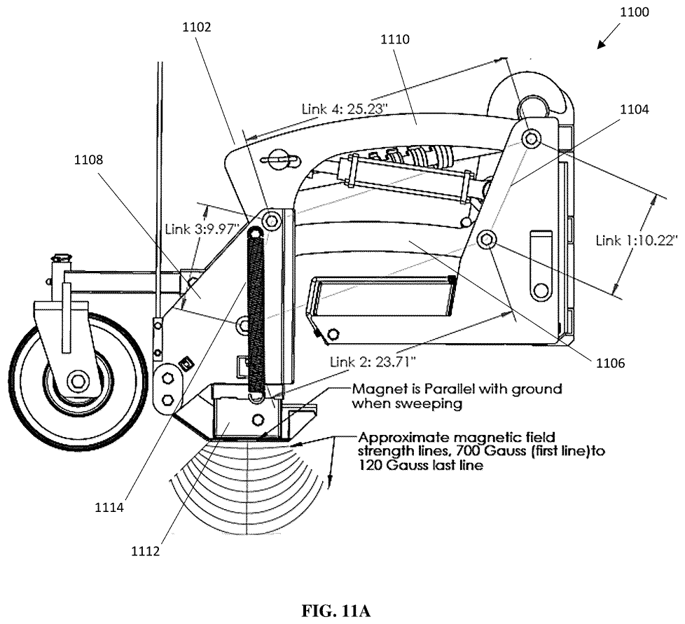

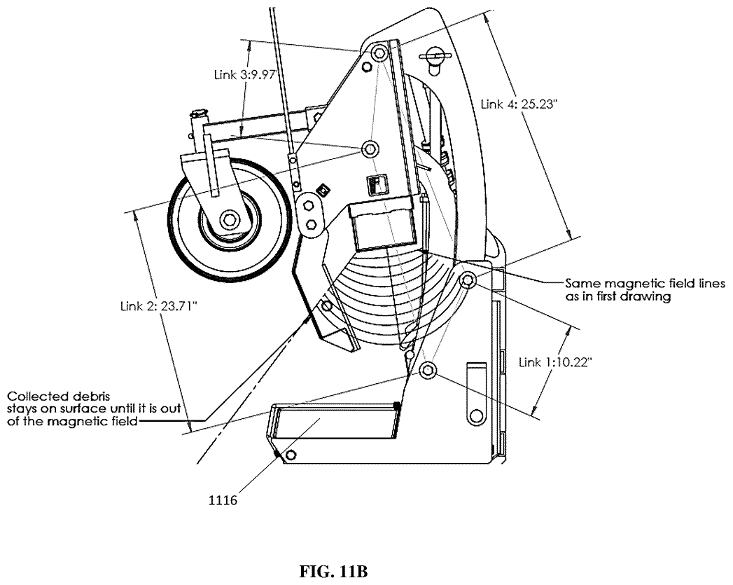

FIGS. 11A and 11B are line drawings illustrating the quadric cycle chain mechanism. According to FIG. 11A, a quadric cycle chain mechanism assembly 1102 of the magnetic sweeper 1100 comprises of a 4-bar mechanism (i.e., link1 1104, link2 1106, link3 1108 and link4 1110) wherein varying center-to-center lengths allow the magnet to be parallel with the ground when sweeping in the 2-6″ range. In a sweeping position (horizontal position), the center-to-center length for link1 1104 is 10.22″, link2 1106 is 23.71″, link3 1108 is 9.97″ and link4 1110 is 25.23″.

According to FIG. 11A, the drawn circular profiles extending from the magnet surface show the rough magnetic field lines (i.e., 700 Gauss line to 120 Gauss line). Furthermore, the hanging magnet 1112 is parallel with the ground when sweeping.

According to FIG. 11B, as the quadric cycle mechanism is lifted, the relationship between the four links allows the magnet to re-direct its magnetic field away from the debris bins. When coupled with an extension spring 1114 and a nylon rope (shown in FIG. 10C and FIG. 10D), the combination allows the collected debris to be placed outside the magnetic field, which lets the debris fall into the on-board storage bins 1116. According to the disclosure, the nylon rope provides a means to open up the metallic bottom pan when the attachment is cycled from the sweeping position to the clean off position.

According to FIG. 11B, at the top of the cycle, the magnet pivots away from the stainless steel pan and the leading edge of the debris bins which moves the collected debris out of the magnetic field. This means the debris falls into the on-board debris storage bins. The drawn circular profiles extending from the magnet surface show the rough magnetic field lines.

According to FIG. 11B, in a vertical position the length of the 4 links including link1 with a length of 10.22″, link2 with a length of 23.71″, link3 with a length of 9.97″ and link4 with a length of 25.23″. According to FIGS. 11A and 11B, links 1-4 are steel part, however, other linking mechanisms can also be used including aluminum, titanium, other metal linkage components. A hydraulic cylinder (on each side) controls the movement and position of the links but is not a link in itself. In addition to hydraulics, the actuation may also be done using a linear actuator, gear motor or other known mechanism.

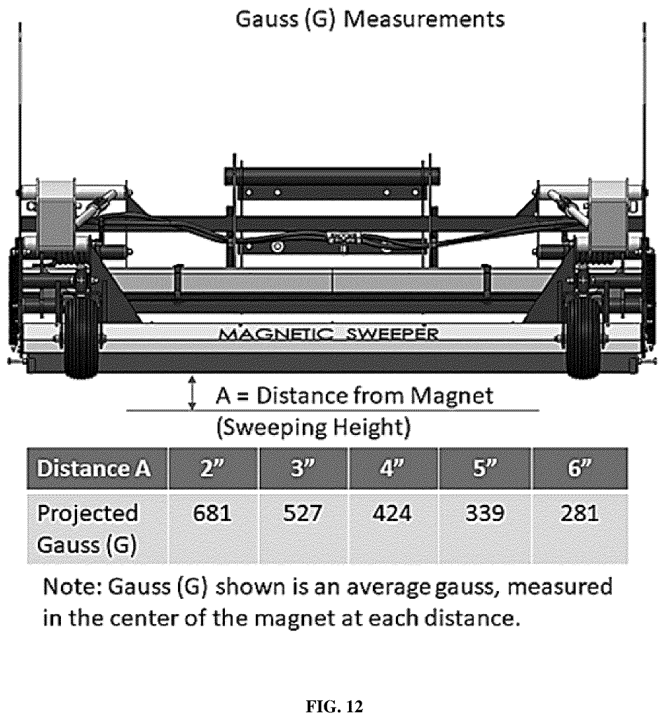

FIG. 12 is a diagram that illustrates the Gauss (G) measurements for the magnetic strength of the magnetic sweeper. According to FIG. 12, sweeping height A is the distance from the magnet. The following table (also shown in FIG. 12) illustrates the relationship between sweeping height and magnet strength (in Gauss):

| Distance A | 2″ | 3″ | 4″ | 5″ | 6″ |
|---|---|---|---|---|---|
| Project Gauss | 681 | 527 | 424 | 339 | 281 |
| (G) | | | | | |

According to FIG. 12, the closer the sweeping height (Distance A), the stronger the magnetic force and the larger the sweeping height, the smaller the magnetic strength. For example, at 2″, the magnetic strength is 681 G and at 6″, the magnetic strength is 281 G.

According to the disclosure, the use of a quadric cycle chain mechanism allows the magnet to be cleaned off as it is lifted or lowered hydraulically. The mechano-hydraulic system was designed so that magnet clean off is done in one smooth motion using one hydraulic circuit, which allows for less parts to be used, and makes serviceability easier. To accomplish the same goal of cleaning off debris into a bin using hydraulics and a wireless remote, it may be possible to create an assembly that uses a rotating mechanism instead of a lifting mechanism.

According to the disclosure, the magnetic sweeper is composed of steel, stainless-steel and aluminum parts. Ceramic magnets are used to make up the magnet itself. UHMW plastic bushings, nylon rope, FRP poles or markers, rubber hoses and copper wiring are also used in construction. Future iterations of the magnetic sweeper can also be constructed from fiberglass, titanium, or magnesium. Plastic or steel substitutes for bushings, visual indicators and other components may also be present. The rope may be in another form as well.

According to the disclosure, metallic objects (or metallic debris) as small as paperclips, up to large items like rail spikes and steel axles are able to be safely retrieved and retained beneath the magnet. Obstructions such as sharp ramps, speedbumps, potholes, small curbs, ruts, and other rough terrain can be traversed without having to sacrifice lifting the magnet which reduces magnetic performance. A quadric cycle chain mechanism allows for magnet clean off and debris storage in a smooth and controlled motion.

According to the disclosure, a front-mount mechano-hydraulic magnetic sweeper apparatus configured for attachment to an industrial vehicle for magnetic sweeping of metallic debris is disclosed. The apparatus comprises a frame, an attachment bracket configured for attachment of the frame to the industrial vehicle, a hanging magnet connected to the front of the apparatus, a metallic bottom pan configured as the bottom surface of the hanging magnet configured for magnetic attachment of metallic debris, a hydraulic assembly configured for moving the components of the apparatus from a sweeping position to a clean-off position, a plurality of storage bins on the frame to store metallic debris, a pair of front wheels, a pair of front wheel forks connecting the front wheels to the frame and a pair of ropes connecting the hanging magnet to the frame of the apparatus, an extension spring for holding the metallic bottom pan up against the bottom surface of the magnet. The magnetic sweeper apparatus is configured to be deployed in a sweeping position to a clean-off position.

According to the disclosure, in the sweeping position, the magnetic sweeper apparatus is deployed whereby the front wheels are close to the ground and the hanging magnet is parallel to the ground and metallic debris is collected at the bottom pan using magnetic force. According to the disclosure in a vertical clean off position, the magnet is lifted vertically and the pan is held down by the nylon rope thereby creating a weaker magnetic force, allowing gravity to clean off the metallic debris away from magnetic sweeper attachment and having the metallic debris deposited into the storage bin.

According to the disclosure, in the clean off position, the front wheels are placed in vertical position and the magnetic sweeper apparatus is lifted vertically by mechano-hydraulic assistance. The metallic bottom pan is a stainless steel pan or an aluminum pan.

According to the disclosure, the apparatus further comprises a fibre-reinforced plastic (FRP) marker, the FRP marker configured for visual line of sight for the operator of the vehicle to know the approximate outer limits of the apparatus. The apparatus further comprises one or more torsion spring configured for shock absorption and weight displacement of the hanging magnet.

According to the disclosure, the rope of the apparatus is a nylon rope, wherein the nylon rope provides a means to open up the metallic bottom pan when the attachment is cycled from the sweeping position to the clean off position. According to the disclosure, the front wheels of the apparatus do not touch the ground in a stationary position and can touch the ground in operation in the sweeping position. According to the disclosure, the industrial vehicle is selected from a list consisting of snow plows, flatbed trucks, tankers, reefers and tow trucks.

According to the disclosure, the apparatus further comprises of four links, wherein in the sweeping position, the center-to-center length for link1 is 10.22″, link2 length of 23.71″, link3 length of 9.97″ and link4 length of 25.23″; and in the clean off position, the center-to-center length for link1 is 10.22″, link2 length of 23.71″, link3 length of 9.97″and link4 length of 25.23″.

According to the disclosure, the apparatus has dimensions of 102.49″ width by 52.35″ length by 35.11″ height and a height of 56.34″ to the tip of the FRP marker. The apparatus is constructed from steel, fiberglass, titanium, or magnesium.

According to the disclosure, the hanging magnet is a permanent magnet and is constructed from Ceramic 8, Alnico magnets or rare earth magnet. The hanging magnet has dimensions of 94.5″ length by 6″ width by 5″ height.

According to the disclosure, a method of removing metallic debris, using front-mount mechano-hydraulic magnetic sweeper attachment on an industrial vehicle is disclosed. The method comprises the steps of placing the magnetic sweeper attachment in horizontal sweeping position, the magnetic sweeper attachment further comprising a storage bin, a bottom metallic pan surface, a rope and a hanging magnet, attracting metal debris at the bottom of the metallic plan of magnetic sweeper attachment and placing the magnetic sweeper attachment in vertical clean off position.

According to the disclosure, in a vertical clean off position of the method, the magnet is lifted vertically and the pan is held down by the rope thereby creating a weaker magnetic force, allowing gravity to clean off the metallic debris away from magnetic sweeper attachment and having the metallic debris deposited into the storage bin, the movement of the magnetic sweeper attachment is driven by mechano-hydraulic means.

According to the disclosure, the magnetic sweeper attachment of the method has ground clearance of 1″ to 2″. The magnetic sweeper attachment of the method further comprises a fibre-reinforced plastic (FRP) marker, the FRP marker is configured for visual line of sight for the operator of the vehicle to know the approximate outer limits of the attachment.

According to the disclosure, the rope of the method is a nylon rope, wherein the nylon rope provides a means to open up the metallic bottom pan when the attachment is cycled from the sweeping position to the clean off position.

According to the disclosure, the magnetic sweeper attachment of the method further comprises four links, wherein in the sweeping position, the center-to-center length for link1 is 10.22″, link2 length of 23.71″, link3 length of 9.97″ and link4 length of 25.23″ and in the clean off position, the center-to-center length for link1 is 10.22″, link2 length of 23.71″, link3 length of 9.97″and link4 length of 25.23″.

According to the disclosure, the apparatus of the method has dimensions of 102.49″ width by 52.35″ length by 35.11″ height and a height of 56.34″ to the tip of the FRP marker. The hanging magnet of the method has dimensions of 94.5″ length by 6″ width by 5″ height and is a permanent magnet and is constructed from Ceramic 8, Alnico magnets or rare earth magnets.

While some embodiments or aspects of the present disclosure may be implemented in fully functioning mechanical, electrical and electrical-mechanical systems, other embodiments may be considered.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

The specific embodiments described above have been shown by way of example and understood is that these embodiments may be susceptible to various modifications and alternative forms. Further understood is that the claims are not intended to be limited to the forms disclosed, but to cover all modifications, equivalents, and alternatives falling within the spirit and scope of this disclosure. While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, various changes and modifications in form, material, workpiece, and fabrication material detail may be made, without departing from the spirit and scope of the present disclosure, as set forth in the appended claims, as may be apparent to those of ordinary skill in the art, are also encompassed by the present disclosure.

What is claimed is:

1. A front-mount mechano-hydraulic magnetic sweeper apparatus, configured for attachment to an industrial vehicle for magnetic sweeping of metallic debris, the apparatus comprising:
a frame;
an attachment bracket configured for attachment of the frame to the industrial vehicle;
a hanging magnet connected to the front of the apparatus;
a metallic bottom pan configured as the bottom surface of the hanging magnet configured for magnetic attachment of metallic debris;
a hydraulic assembly configured for moving the components of the apparatus from a sweeping position to a clean-off position;
a plurality of storage bins on the frame to store metallic debris;
a pair of front wheels;
a pair of front wheel forks connecting the front wheels to the frame;
a pair of ropes connecting the hanging magnet to the frame of the apparatus;
an extension spring for holding the metallic bottom pan up against the bottom surface of the magnet;
wherein the magnetic sweeper apparatus is configured to be deployed in a sweeping position to a clean-off position;
wherein in the sweeping position, the magnetic sweeper apparatus is deployed whereby the front wheels are close to the ground and the hanging magnet is parallel to the ground and metallic debris is collected at the bottom pan using magnetic force;
wherein in a vertical clean off position, the magnet is lifted vertically and the pan is held down by the nylon rope thereby creating a weaker magnetic force, allowing gravity to clean off the metallic debris away from magnetic sweeper attachment and having the metallic debris deposited into the storage bin.

2. The apparatus of claim 1 wherein in the clean off position, the front wheels are placed in vertical position and the magnetic sweeper apparatus is lifted vertically by mechano-hydraulic assistance.

3. The apparatus of claim 1 wherein the metallic bottom pan is a stainless steel pan or an aluminum pan.

4. The apparatus of claim 1 further comprising a fibre-reinforced plastic (FRP) marker, the FRP marker configured for visual line of sight for the operator of the vehicle to know the approximate outer limits of the apparatus.

5. The apparatus of claim 1 further comprising one or more torsion spring configured for shock absorption and weight displacementof the hanging magnet.

6. The apparatus of claim 1 wherein the rope is a nylon rope, wherein the nylon rope provides a means to open up the metallic bottom pan when the attachment is cycled from the sweeping position to the clean off position.

7. The apparatus of claim 1 wherein the front wheels do not touch the ground in a stationary position and can touch the ground in operation in the sweeping position.

8. The apparatus of claim 1 wherein the industrial vehicle is selected from a list consisting of snow plows, flatbed trucks, tankers, reefers and tow trucks.

9. The apparatus of claim 1 wherein the apparatus further comprises of four links, wherein in the sweeping position, the center-to-center length for link1 is 10.22″, link2 length of 23.71″, link3 length of 9.97″ and link4 length of 25.23″; and
in the clean off position, the center-to-center length for link1 is 10.22″, link2 length of 23.71″, link3 length of 9.97″and link4 length of 25.23″.

10. The apparatus of claim 1 wherein the apparatus has dimensions of 102.49″ width by 52.35″ length by 35.11″ height and a height of 56.34″ to the tip of the FRP marker.

11. The apparatus of claim 1 wherein the hanging magnet is a permanent magnet and is constructed from Ceramic 8, Alnico magnets or rare earth magnet.

12. The apparatus of claim 1 wherein the hanging magnet has dimensions of 94.5″ length by 6″ width by 5″ height.

13. The apparatus of claim 1 wherein the apparatus is constructed from steel, fiberglass, titanium, or magnesium.

14. A method of removing metallic debris, using front-mount mechano-hydraulic magnetic sweeper attachment on an industrial vehicle, the method comprising the steps of:
placing the magnetic sweeper attachment in horizontal sweeping position, the magnetic sweeper attachment further comprising a storage bin, a bottom metallic pan surface, a rope and a hanging magnet;
attracting metal debris at the bottom of the metallic plan of magnetic sweeper attachment; and
placing the magnetic sweeper attachment in vertical clean off position;
wherein in a vertical clean off position, the magnet is lifted vertically and the pan is held down by the rope thereby creating a weaker magnetic force, allowing gravity to clean off the metallic debris away from magnetic sweeper attachment and having the metallic debris deposited into the storage bin;
wherein the movement of the magnetic sweeper attachment is driven by mechano-hydraulic means.

15. The method of claim 14 wherein the magnetic sweeper attachment has ground clearance of 1″ to 2″.

16. The method of claim 1 wherein the magnetic sweeper attachment further comprises a fibre-reinforced plastic (FRP) marker, the FRP marker is configured for visual line of sight for the operator of the vehicle to know the approximate outer limits of the attachment.

17. The method of claim 14 wherein the rope is a nylon rope, wherein the nylon rope provides a means to open up the metallic bottom pan when the attachment is cycled from the sweeping position to the clean off position.

18. The method of claim 14 wherein the magnetic sweeper attachment further comprises four links, wherein in the sweeping position, the center-to-center length for link1 is 10.22″, link2 length of 23.71″, link3 length of 9.97″ and link4 length of 25.23″; and
in the clean off position, the center-to-center length for link1 is 10.22″, link2 length of 23.71″, link3 length of 9.97″and link4 length of 25.23″.

19. The method of claim 14 wherein the apparatus has dimensions of 102.49″ width by 52.35″ length by 35.11″ height and a height of 56.34″ to the tip of the FRP marker.

20. The method of claim 14 wherein the hanging magnet has dimensions of 94.5″ length by 6″ width by 5″ height and is a permanent magnet and is constructed from Ceramic 8, Alnico magnets or rare earth magnets.
